(19) United States
(12) Patent Application Publication
(10) Pub. No.: US 2026/0323578 A1
(43) Pub. Date: Oct. 15, 2026

(54) METHODS AND APPARATUSES FOR SELECTING A RANGING TECHNIQUE

(71) Applicant: Telefonaktiebolaget LM Ericsson (publ), Stockholm (SE)

(72) Inventors: Ritesh SHREEVASTAV, Upplands Väsby (SE); Xiaolin JIANG, Linköping (SE); Richárd BÁTORFI, Budapest (HU)

(73) Assignee: Telefonaktiebolaget LM Ericsson (publ), Stockholm (SE)

(21) Appl. No.: 19/483,901

(22) PCT Filed: May 10, 2024
(86) PCT No.: PCT/IB2024/054540

§ 371 Date: Nov. 12, 2025

Related U.S. Application Data
(60) Provisional application No. 63/465,997, filed on May 12, 2023.

(51) Int. Cl. H04W 64/00; H04W 8/26; H04W 92/18

(52) U.S. Cl. CPC H04W 64/00; H04W 8/26; H04W 92/18

(57) ABSTRACT

A network node configured to provide a location server can receive a first message including a request for information associated with a distance between a first communication device and a second communication device. The network node can determine whether to instruct the first communication device to perform a sidelink, SL, ranging procedure to determine the distance between the first communication device and the second communication device. The network node can determine the information associated with the distance between the first communication device and the second communication device based on an absolute position of the first communication device and an absolute position of a second communication device. The network node can transmit an indication of the information.

### TECHNICAL FIELD

The present disclosure is related to wireless communication systems and more particularly to sidelink ranging with network assistance information.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Positioning has been a topic in LTE standardization since 3GPP Release 9. The primary objective is to fulfill regulatory requirements for emergency call positioning. Positioning in NR is proposed to be supported by the architecture shown in FIG. 1. LMF is the location node in NR. There are also interactions between the location node and the gNodeB via the NRPPa protocol. The interaction between the gNodeB and the device is supported via the Radio Resource Control (RRC) protocol.

FIG. 2 illustrates an example of NR architecture for supporting NR positioning. In this example, the location node in NR is a location management function (“LMF”). There are also interactions between the location node and the gNodeB via the NR Positioning Protocol A (“NRPPa”). The interactions between the gNodeB and the device is supported via the Radio Resource Control (“RRC”) protocol, while the location node interfaces with the UE via the LTE Positioning Protocol (“LPP”). LPP is common to both NR and LTE. While FIG. 2 shows both a gNB and an ng-eNB, both may not always be present. Further, when both the gNB and the ng-eNB are present, the NG-C is generally only present for one of them.

LTE supports: 1) an enhanced cell identifier (“ID”); 2) assisted global navigation satellite system (“GNSS”); 3) observed time-difference-of-arrival (“OTDOA”); 4) uplink (“UL”) time-difference-of-arrival (“TDOA”); and 5) sensor techniques. Enhanced cell ID includes cell ID information to associate the device to the serving area of a serving cell, and then additional information to determine a finer granularity position. Assisted GNSS information can be retrieved by the device and supported by assistance information provided to the device from (“E-SMLC”). OTDOA includes the device estimating the time difference of reference signals from different base stations and sending the information to the E-SMLC for multilateration. UTDOA includes the device requesting to transmit a specific waveform that is detected by multiple location measurement units (e.g., an eNB) at known positions. These measurements are forwarded to E-SMLC for multilateration. LTE sensor techniques can include a Biometric pressure sensor that provides vertical position of the device and an Inertial Motion Unit (“IMU”) that provides displacement.

### SUMMARY

According to some embodiments, a method of operating a network node is provided. The network node is configured to provide a location server. The method includes receiving a first message including a request for information associated with a distance between a first communication device and a second communication device. The method further includes determining whether to instruct the first communication device to perform a sidelink, SL, ranging procedure to determine the distance between the first communication device and the second communication device. The method further includes determining the information associated with the distance between the first communication device and the second communication device based on an absolute position of the first communication device and an absolute position of a second communication device. The method further includes transmitting an indication of the information.

According to other embodiments, a method of operating a client device is provided. The method includes transmitting a first message including a request for information associated with a distance between a first communication device and a second communication device. The method includes receiving a second message including the information associated with the distance between the first communication device and the second communication device. The information associated with the distance between the first communication device and the second communication device includes an indication that the distance between the first communication device and the second communication device was determined based on an absolute position of the first communication device and an absolute position of the second communication device.

According to other embodiments, a network node, location server, location management function, client device, communication device, system, or host is provided to perform one of the above methods.

Certain aspects of these embodiments may provide technical advantages. In some embodiments, the proposed solutions enable a LMF to choose a suitable technique for obtaining a ranging result, which can further guarantee a quality of service (“QoS”) of the ranging.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a block diagram illustrating an example of NR architecture for supporting positioning in NR;

FIG. 3A is a schematic diagram illustrating an example of an assisting UE and a target UE in a full coverage position;

FIG. 3B is a schematic diagram illustrating an example of an assisting UE and a target UE in a partial coverage position;

FIG. 3C is a schematic diagram illustrating an example of an assisting UE and a target UE in an out-of-coverage position;

FIGS. 4A-B are schematic diagrams illustrating examples in which multiple assisting UEs assist a target UE;

FIG. 5 is a signal flow diagram illustrating an example of signals communicated as part of SL ranging with network assistance information in accordance with some embodiments;

FIG. 6 is a flow chart illustrating an example of operations performed by a communication device in accordance with some embodiments;

FIG. 7 is a flow chart illustrating an example of operations performed by a network node configured to provide an AMF in accordance with some embodiments;

FIG. 8 is a flow chart illustrating an example of operations performed by a network node configured to provide an LMF in accordance with some embodiments;

FIG. 9 is a block diagram of a communication system in accordance with some embodiments;

FIG. 10 is a block diagram of a user equipment in accordance with some embodiments;

FIG. 11 is a block diagram of a network node in accordance with some embodiments;

FIG. 12 is a block diagram of a host, which may be an embodiment of the host of FIG. 9, in accordance with some embodiments;

FIG. 13 is a block diagram of a virtualization environment in accordance with some embodiments; and

FIG. 14 shows a communication diagram of a host communicating via a network node with a user equipment over a partially wireless connection in accordance with some embodiments.

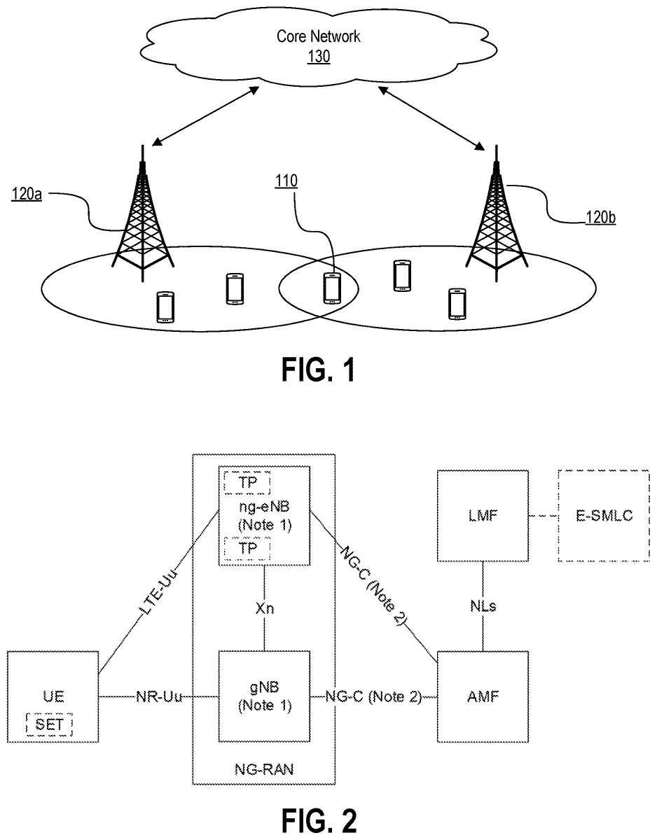

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

NR currently supports the following radio access technology (“RAT”) dependent positioning procedures: 1) Downlink time-difference-of-arrival (“DL-TDOA”); 2) Multi-round trip time (“RTT”); 3) Uplink time-difference-of-arrival (“UL-TDOA”); 4) Downlink angle-of-departure (“DL-AoD”); 5) Uplink angle-of-arrival (“UL-AoA”); and 6) NR enhanced cell identifier (“NR-ECID”).

The DL TDOA positioning procedure makes use of the downlink (“DL”) reference signal time difference (“RSTD”) (and optionally DL positioning reference signal (“PRS”) reference signal received power (“RSRP”)) of downlink signals received from multiple transmission points (“TPs”), at the UE. The UE measures the DL RSTD (and optionally DL PRS RSRP) of the received signals using assistance data received from the positioning server, and the resulting measurements are used along with other configuration information to locate the UE in relation to the neighboring TPs.

The Multi-RTT positioning procedure makes use of the UE reception (“Rx”)-transmission (“Tx”) measurements and DL PRS RSRP of downlink signals received from multiple transmission/reception points (“TRPs”), measured by the UE and the measured gNB Rx-Tx measurements and UL sounding reference signal (“SRS”)-RSRP at multiple TRPs of uplink signals transmitted from UE.

The UL TDOA positioning procedure makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

The DL AoD positioning procedure makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

The UL AoA positioning procedure makes use of the measured azimuth and zenith of arrival at multiple reception points (“RPs”) of uplink signals transmitted from the UE. The RPs measure A-AoA and Z-AoA of the received signals using assistance data received from the positioning server, and the resulting measurements are used along with other configuration information to estimate the location of the UE.

NR-ECID positioning refers to techniques that use additional UE measurements and/or NR radio resource and other measurements to improve the UE location estimate.

The positioning modes can be categorized into three areas: 1) UE-Assisted; 2) UE-Based; and 3) Standalone. UE-Assisted can refer to the UE performing measurements with or without assistance from the network and sending these measurements to the E-SMLC where the position calculation may take place. UE-Based can refer to the UE performing measurements and calculating its own position with assistance from the network. Standalone can refer to the UE performing measurements and calculating its own without network assistance. There currently exist certain challenges. In some examples, the ranging result between two certain UEs is of interest. The ranging result can either be obtained by: 1) two UEs performing ranging measurements; or 2) calculated by the absolute positions of the two UEs. A location server (e.g., a location management server (“LMF”)) can decide which technique to use for determining the ranging result. However, how the location server selects the best technique is not specified. Performing both techniques can cause an increase of latency and energy consumption, while randomly picking a method may not obtain ranging results that meets quality of service (“QoS”) or even fail to obtain a ranging result.

Certain aspects of the disclosure and their embodiments may provide solutions to these or other challenges. In some embodiments, a location server (e.g., LMF) can receive a ranging request for at least two UEs (e.g., UE1 and UE2) and the serving cell information of the two UEs (e.g., UE1 and UE2). In additional or alternative embodiments, the location server can decide a suitable technique for ranging based on the serving cell information of the two UEs (UE1 and UE2) and selecting rules. In additional or alternative embodiments, the location server can request the two UEs (UE1 and UE2) to perform ranging measurements over PC5 or absolute positioning for each of UEs (UE1 and UE2).

In additional or alternative embodiments, based on the serving cells' information of two UEs to be ranged, a LMF can decide a technique for ranging. If the serving cells of the two UEs are neighbor cells or close in distance, the LMF can instruct the UEs to perform ranging measurement, otherwise the LMF can request absolute positions of the two UEs for ranging result calculation.

The term, network node, may be used herein and can refer to one or more of a NodeB, base station (“BS”), multi-standard radio (“MSR”) radio node such as MSR BS, eNodeB, gNodeB, MeNB, SeNB, location measurement unit (“LMU”), integrated access backhaul (“IAB”) node, network controller, radio network controller (“RNC”), base station controller (“BSC”), relay, donor node controlling relay, base transceiver station (“BTS”), Central Unit (e.g., in a gNB), Distributed Unit (e.g., in a gNB), Baseband Unit, Centralized Baseband, central radio access network (“C-RAN”), access point (“AP”), transmission points, transmission nodes, transmission reception point (“TRP”), remot radio unit (“RRU”), remote radio head (“RRH”), nodes in distributed antenna system (“DAS”), core network node (e.g., MSC or mobility management entity (“MME”)), operations & maintenance (“O&M”), operations support system (“OSS”), self-organizing network (“SON”), or positioning node (e.g., E-SMLC).

The term, communication device, may be used herein to refer to a user equipment (“UE”) or to any type of wireless device communicating with a network node and/or with another UE in a cellular or mobile communication system. Examples of communication devices include a target device, a device to device (“D2D”) UE, a vehicular to vehicular (“V2V”), a machine type UE, a machine time communication (“MTC”) UE, a UE capable of machine to machine (“M2M”) communication, a personal digital assistant (“PDA”), tablet, mobile terminals, smart phone, laptop embedded equipment (“LEE”), laptop mounted equipment (“LME”), and universal serial bus (“USB”) dongles.

The term, radio access technology (“RAT”), may be used herein to refer to any RAT (e.g., universal mobile telecommunications system terrestrial radio access (“UTRA”), evolved-UTRA (“E-UTRA”), narrow band internet of things (“NB-IoT”), WiFi, Bluetooth, next generation RAT, New Radio (“NR”), fourth generation (“4G”), and fifth generation (“5G”)). Any of the equipment denoted by the term node, network node, or radio network node may be capable of supporting a single or multiple RATs.

The term, time resource, may be used herein to refer to any type of physical resource or radio resource expressed in terms of length of time. Examples of time resources include symbol, time slot, subframe, radio frame, transmission time interval (“TTI”), interleaving time, slot, sub-slot, mini-slot, system frame number (“SFN”), and hyper SFN (“H-SFN”). During a time resource a physical channel can be encoded and interleaved for transmission by the transmitter or decoded and received by the receiver.

The term, time-frequency resource, may be used herein to refer to any radio resource defined in any time-frequency resource grid in a cell. Examples of time-frequency resource are resource block (“RB”) and subcarrier. The RB may also be interchangeably called a physical RB (“PRB”) or virtual RB (“VRB”).

The term, wireless access network (“WAN”), may be used herein to refer to a radio network involving communication between a UE and a network node (e.g., a base station). In general, a WAN refers to any radio link, radio interface, or radio entity that is used for or is involved in operating WAN signals. The signals transmitted between the UE and the network node can be referred to herein as WAN signals. The signal transmitted by the UE to the network node can be referred to as an uplink (“UL”) WAN signal. The signal transmitted by the network node to the UE can be referred to as a downlink (“DL”) WAN signal. The WAN may also interchangeably be referred to as a cellular network, a radio access network (“RAN”), a Uu interface, or a radio network interface. The corresponding link or radio link over which the WAN signals are transmitted can also be referred to herein as the WAN link, RAN link, Uu link, UL, DL, forward link (BS transmission to UE), or reverse link (UE transmission to BS). Therefore, the WAN link can also be referred to as a WAN UL, UL WAN, WAN DL, or DL WAN. The corresponding signals transmitted between the UE and the network node, may also interchangeably be referred to as cellular signals, Uu signals, or RAN signals. The WAN signals may belong to or operate in any type of RAT (e.g., LTE or NR). In some embodiments, the generic term WAN link and WAN signals are used.

The term, sidelink (“SL”), may be used herein to refer to a radio link over which the signals are transmitted between at least two UEs for D2D operation. The signals transmitted between the UEs for D2D operation can be referred to herein as SL signals. The term SL may also interchangeably be referred to as D2D link, V2X link, prose link, peer-to-peer link, or PC5 link. The SL signals may also interchangeably be referred to as V2X signals, D2D signals, prose signals, PC5 signals, or peer-to-peer signals.

The term, in coverage (“IC”), used herein includes a scenario in which the UE is under the full coverage of one or more network nodes (e.g., serving cells). For example, if the UE can detect at least one cell then it is considered to be in IC. In additional or alternative examples, if the UE can detect at least one cell on carrier on which it is configured to perform sidelink operation then it is considered to be in IC. In additional or alternative examples, if the UE detects at least one cell on the frequency that the UE is configured to perform sidelink operation on fulfilling the S criterion, then it considers itself to be in-coverage for sidelink operation on that frequency. The UE in IC is able to receive signals from and/or transmit signals to at least one network node. The UE can also maintain a communication link with the network. The IC can also be interchangeably referred to as In Network Coverage (“INC”).

The term, partial coverage (“PC”), may be used herein to refer to a scenario in which at least one of the UEs among the UEs involved in sidelink communication is under the network coverage (e.g., is IC), and at least one UE is not under network coverage (e.g., on OOC). The PC is also interchangeably referred to as Partial Network Coverage (“PNC”).

The term, out of coverage (“OOC”), may be used herein to refer to a scenario in which none of the UEs involved in sidelink communication are under network coverage. In some examples, in OOC, the UE is not associated with a serving cell on any carrier. In additional or alternative examples, if the UE cannot detect any cell then it can consider itself to be in OOC. If the UE cannot detect any cell on that frequency meeting the S criterion then it can consider itself to be out-of-coverage for sidelink operation on that frequency. In additional or alternative examples, if the UE cannot detect any cell on any carrier on which it is configured to perform sidelink operation then it can consider itself to be in OOC. The OOC is also interchangeably referred to as Out-Of-Network Coverage (“ONC”).

The term, SL positioning reference signal (“SL PRS”), can be used to denote any reference signal (“RS”) (e.g., SL PRS or SL sounding reference signal (“SRS”)) used for an SL positioning measurement.

The term, SL reference signal (“SLRS”), can be used in the embodiments to refer to any type of RS which can be transmitted by a UE on a SL. Examples of such RS include SL PRS, SL SRS, SL-SSSB, SLSS, S-PSS, S-SSS, PSBCH or any combination (e.g., S-SS/PSBCH (S-SS+S-PSS+PSBCH)).

The term, SL resource pool, can be used to refer to the overall time/frequency resource that can be used for SL communication and/or SL positioning within a carrier. In the time domain the resource pool can include a set of time resources (e.g., symbols, slots, and subframes) transmitted over a resource pool period. In the frequency domain the resource pool can include a set of frequency resources (e.g., subchannels), where a frequency resource (e.g., subchannel) can include a number of resource blocks. The number of frequency resources (e.g., subchannels) can be consecutive or non-consecutive in the frequency domain. The number of RBs within a frequency resource may be consecutive or non-consecutive in frequency domain.

The term, SL positioning resource pool, can be used in the embodiments to refer to a SL resource pool that can be used to transmit a SL positioning reference signal. A SL positioning resource pool can include a dedicated SL resource pool for SL positioning and a shared SL resource pool for both SL positioning and SL communication. One SL positioning resource pool may support multiplexing in the time domain and/or support Comb-N SL-PRS design in the frequency domain.

The term, target UE, can be used to refer to a UE whose distance, direction, and/or position is measured with the support from one or multiple SL Reference UEs using Sidelink in the Ranging based service and Sidelink positioning.

The term, SL Reference UE, can be used to refer to a UE, supporting positioning of target UE (e.g., by transmitting and/or receiving reference signals for positioning or providing positioning-related information) using sidelink.

The term, SL positioning UE server, can be used to refer to a UE offering location calculation, for Sidelink Positioning and Ranging based service. It can interact with other UEs over PC5 as necessary in order to calculate the location of the Target UE. The arget UE or SL Anchor UE can act as SL Positioning Server UE if location calculation is supported.

A location services (“LCS”) Client can refer to an entity that interacts with a gateway mobile location center (“GMLC”) for the purpose of obtaining location information for one or more UEs. In some examples, the LCS Client may reside in the UE.

A SL Positioning Client UE can refer to a third-party UE, other than a SL Reference UE and a Target UE, which initiates a Ranging/Sidelink positioning service request on behalf of the application residing on it.

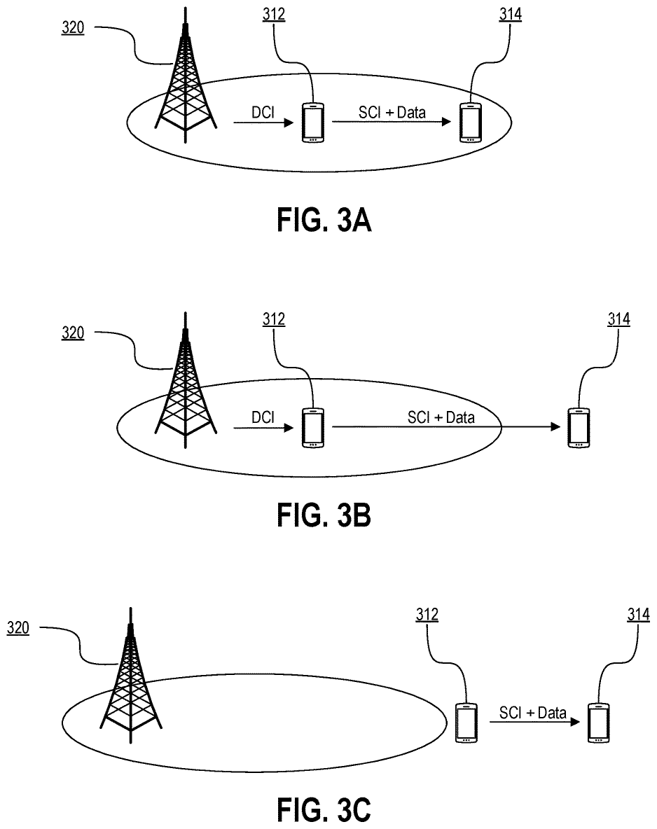

In FIGS. 3A-C, an assisting user equipment (“UE”) 312 (which may be also referred to herein as a reference UE or an anchor UE) provides sidelink (“SL”) measurement assistance to a target UE 314. FIG. 3A illustrates an example of an assisting UE and the target UE fully in coverage of a gNB 320. FIG. 3B illustrates an example of the assisting UE in coverage of the gNB 320 and the target UE out of coverage of the gNB 320, which can be referred to as in partial coverage. FIG. 3C illustrates an example of in which the assisting UE 312 and the target UE 314 are out of coverage of the gNB 320, which can be referred to as being in an out-of-coverage position. In this example, there may be different options for the target UE 314 to get positioned. In one example, the target UE 314 may choose to connect to the network via a SL UE-to-Network (“U2N”) relay UE. In this example, the network can be involved in the positioning procedure for the target UE 314. In additional or alternative examples, the target UE 314 may apply UE based positioning by involving an assisting UE 312. If there is not any assisting UE found in the proximity, the target UE 314 can reach an assisting UE in further range via a UE-to-UE (“U2U”) relay UE.

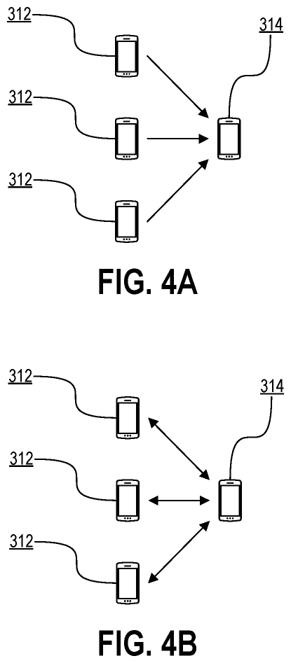

The same positioning techniques discussed above (e.g., downlink time-difference-of-arrival (“DL-TDOA”), uplink time-difference-of-arrival (“UL-TDOA”), and Multi-round trip time (“RTT”)) can be expected to be applicable for SL based positioning. For these techniques, multiple assisting/reference UEs may be required, as illustrated in FIGS. 4A-B.

For SL based positioning, certain techniques such as TDOA may require tight sync among multiple assisting/reference UEs 312 so that the transmissions of positioning reference signals from these reference UEs 312 can arrive at the target UE 314 in a synchronized fashion. This can improve both positioning accuracy and avoid interference among reference UEs 312. FIG. 4A illustrates an example of an architecture for SL positioning and ranging using TDOA. FIG. 4B illustrates an example of an architecture for SL positioning and ranging using Multi-RTT.

According to the latest 3^{rd} Generation Partnership Project (“3GPP”) discussion, it has been agreed to support two different schemes to position a target UE based on SL positioning. In the first scheme, the target UE and/or anchor UEs measures or perform SL positioning transmissions using SL resources scheduled/allocated by the gNB. In the second scheme, the target UE and/or anchor UEs measures or perform SL positioning transmissions using SL resources scheduled/allocated by the UE itself.

The first scheme (Scheme 1) can correspond to Mode 1 random access (“RA”) operation, while the second scheme (Scheme 2) can correspond to Mode 2 RA operation.

A SL positioning measurement performed by a target UE can be used for determining a position/location of that target UE. The target UE can perform a SL positioning measurement on SL reference signals (e.g., SL PRS or SL SRS) transmitted by one or more anchor UEs and/or on SL reference signals (e.g., SL PRS or SL SRS) transmitted by the target UE itself. Examples of the possible SL positioning measurements include: a SL receive (“Rx”)-transmit (“Tx”) time difference measurement; a SL reference signal time different (“RSTD”) measurement; a SL reference signal receive power (“RSRP”) measurement; a SL RSRPP measurement; a SL relative time of arrival (“RTOA”) measurement; a SL azimuth angle of arrival (“AoA”) measurement; a SL zenith angle of arrival (“ZoA”) measurement; and a SL pathloss measurement.

A SL Rx-Tx time difference measurement can be defined as TSL-RX-TSL-TX. It may also be referred to as a round trip time (“RTT”) measurement. In some examples, TSL-RX is the received timing of a SL time resource #i (e.g. subframe #i) from an anchor UE, defined by the first detected path in time. It is measured by the target UE on SL PRS signals received from the anchor UE. TSL-TX is the transmit timing of SL time resource #j (e.g. subframe #j) that is closest in time to the time resource #i (e.g. subframe #i) received from the anchor UE. It is measured on SL PRS signals transmitted by the target UE.

A SL RSTD measurement can be a reference signal time difference between two anchor UEs (e.g., between an anchor UE i and a reference anchor UE j). It can be measured by the target UE on SL PRS signals transmitted by the anchor UE i and the reference anchor UE.

A SL RSRP measurement can refer to a SL PRS reference signal received power (e.g., SL PRS-RSRP or a SL RSRP), which can be the linear average over the power contributions (in [W]) of the resource elements that carry SL PRS reference signals. It can be measured by the target UE on the SL PRS transmitted by the anchor UE.

A SL RSRPP measurement can refer to a SL PRS reference signal received power (e.g., SL PRS-RSRPP or SL RSRPP, which can be the linear average of the channel response at the i-th path delay of the of the resource elements that carry SL PRS reference signals. SL RSRPP for the 1st path delay is the power contribution corresponding to the first detected path in time. It can be measured by the target UE on the SL PRS transmitted by the anchor UE.

A SL RTOA measurement can refer to the beginning of SL time resource #i (e.g. subframe #i) including SL PRS received in the target UE, relative to a reference time (e.g. the RTOA Reference Time).

A SL Azimuth AoA measurement can refer to the Azimuth angle of Arrival of the SL PRS transmitted by the anchor UE. It can be measured by the target UE.

A SL Zenith ZoA measurement can refer to the Zenith angle of Arrival of the SL PRS transmitted by the anchor UE. It can be measured by the target UE.

A SL pathloss measurement can refer to a pathloss measurement based on SL positioning reference signals (e.g., SL PRS or SL SRS).

A SL positioning reference signal (“PRS”) can be similar to or identical to a DL positioning reference signal (“PRS”) used for positioning measurement in the WAN (e.g., on a Uu interface). The numerologies of the DL PRS can be the same as defined for general NR operation (e.g., SCS of 15, 30, 60, or 120 kHz). The numerologies of the SL PRS can be limited to those defined for SL operation.

The DL PRS can be periodically transmitted on a positioning frequency layer (“PFL”) in PRS resources in the DL by the gNB. The information about the DL PRS resources can be signaled to the UE by the positioning node via higher layers but may also be provided by base station (e.g., via broadcast). Each positioning frequency layer can include DL PRS resource sets, where each DL PRS resource set includes one or more DL PRS resources. All of the DL PRS resources within one DL PRS resource set can be configured with the same periodicity.

The SL PRS can also be periodically transmitted on a carrier frequency (e.g., a SL positioning frequency layer) in SL PRS resources on the SL by a SL UE. SL PRS can include SL PRS resource sets, where each SL PRS resource set includes one or more SL PRS resources. All the SL PRS resources within one SL PRS resource set can be configured with the same periodicity. The PRS resource periodicity (Tₚₑᵣ^{PRS}), which may refer to DL PRS or SL PRS, can include:

$${T}_{per}^{PRS} ∈ {2}^{μ} \{ 4 , 8 , 16 , 32 , 64 , 5 , 10 , 20 , 40 , 80 , 160 , 320 , 640 , 12 \; 80 , 2560 , 5120 , 10240 , 20480 \}$$

slots, where μ=0, 1, 2, 3 for PRS SCS of 15, 30, 60 and 120 kHz respectively.

$${T}_{per}^{PRS} = {2}^{μ} \cdot 20480$$

is not supported for μ=0. Each PRS resource can also be repeated within one PRS resource set and takes values:

$${T}_{rep}^{PRS} ∈ \{ 1 , 2 , 4 , 6 , 8 , 16 , 32 \} .$$

PRS can be transmitted in consecutive number of symbols (L_{PRS}) within a slot: L_{PRS}∈{2, 4, 6, 12}. The following PRS RE patterns, with comb size K_{PRS} equal to number of symbols L_{PRS} are supported: 1) Comb-2: Symbols {0, 1} have relative RE offsets {0, 1}; 2) Comb-4: Symbols {0, 1, 2, 3} have relative RE offsets {0, 2, 1, 3}; 3) Comb-6: Symbols {0, 1, 2, 3, 4, 5} have relative RE offsets {0, 3, 1, 4, 2, 5}; and 4) Comb-12: Symbols {0, 1, 2, 3, 4, 5, 6, 7, 8, 9, 10, 11} have relative RE offsets {0, 6, 3, 9, 1, 7, 4, 10, 2, 8, 5, 11}. A maximum PRS BW is 272 PRBs. A minimum PRS BW is 24 PRBs. The configured PRS BW may always be a multiple of 4.

The PRS resource set may include parameters such as subcarrier spacing (“SCS”), PRS BW, PRS resource set periodicity and slot offset with regards to reference time (e.g., slot #0), PRS resource repetition factor (e.g., number of times PRS resource repeated in a PRS resource set), PRS symbols in PRS resource, PRS resource time gap (e.g., number of slots between successive repetitions), and PRS muting pattern.

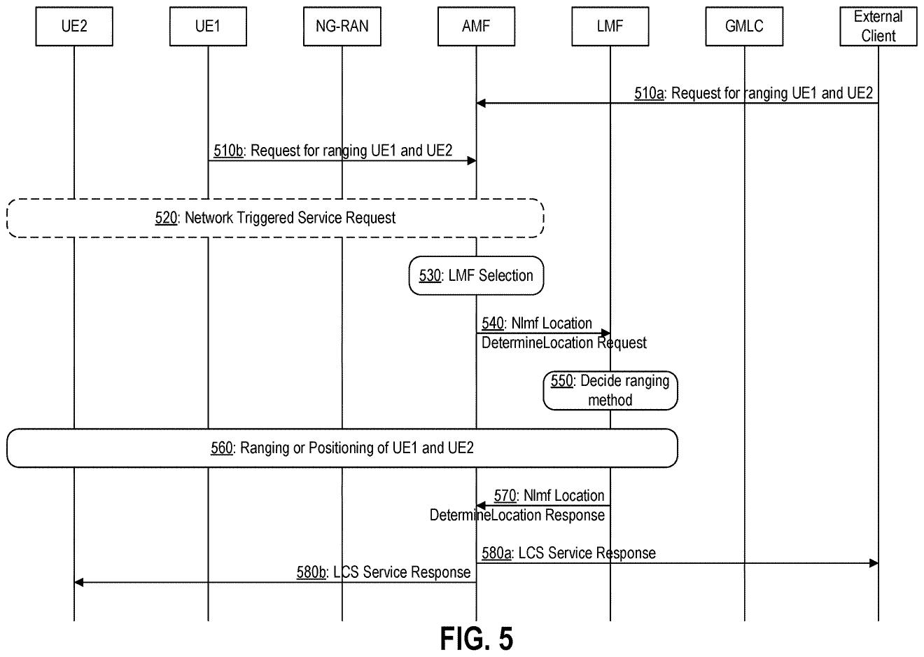

FIG. 5 illustrates an example of signals communicated in order to perform sidelink ranging with network assistance.

At operation 510a, an external client sends a request for ranging between UE1 and UE2. In some examples, the request includes a required QoS. The request may pass through a GMLC to reach a serving access and mobility management function (“AMF”) of UE1. In additional or alternative examples, the UE identifiers (“IDs”) in the request can include a subscription permanent identifier (“SUPI”) and/or an application layer ID of UE1 and UE2.

At operation 510b, a UE sends a request for ranging between itself and another UE2, and the request may include the required QoS. The UE ID(s) in the request may be in one of the following forms. In some examples, the UE ID may be a Uu ID (e.g., TMSI, IMSI, RNTI, GPSI, Resume ID, or an ID computed based on any Uu ID). In additional or alternative examples, the UE ID may be a SL ID (e.g., a L2 ID). In additional or alternative examples, the UE ID may be any ID assigned by the gNB, by a core network entity (e.g., an AMF, SMF, or LMF) or by a controlling UE. The controlling UE may be the UE1 itself.

At operation 520, if UE1 and/or UE2 is in a connection management (“CM”) IDLE state, the AMF can initiate a network triggered Service Request procedure to establish a signaling connection with the UEs.

At operation 530, the AMF selects an LMF based on the available information (e.g., as indicated in clause 5.1 of TS 23.273 or based on AMF local configuration). The LMF selection takes the 5G-AN(s) currently serving the UEs into account. The selection may use a NRF query.

At operation 540, the AMF can invoke a Nlmf_Location_DetermineLocation service operation towards the LMF to request the ranging between UE1 and UE2. The service operation includes a LCS Correlation identifier, SUPI and Application Layer ID of UEL and UE2, and the serving cell ID(s) of UE1 and UE2. The service operation may further include an indication if UEs support LPP, SLPP, the required QoS, UE Positioning Capability if available and Supported GAD shapes. The service operation can further include and identifier of the AMF.

At operation 550, the LMF decides a procedure for ranging based on the serving cells' information of the two UEs to be ranged.

In some examples, ranging between UE1 and UE2 over PC5 will be used if one or more of the following conditions are met: 1) the two UEs have the same the serving cell; 2) the serving cells of the two UEs are neighbor cells or the two serving cells are within a certain distance value; 3) the two UEs supports a same local map/coordinate; 4) one of the UEs is out of NW coverage; 5) UE1 and UE2 both support ranging/SL positioning; and 6) LMF receives SUPI of U1 and receives or is aware Application Layer ID of U2.

In additional or alternative examples, calculating ranging result by absolute positions of the two UEs may be performed if one or more of the following conditions are met: 1) the two serving cells are larger than a certain distance value; 2) UE1 and/or UE2 does not support ranging/SL positioning; and 3) LMF did not receive or cannot translate (for example from SUPI) the Application Layer ID, but both SUPIs are received.

At operation 560, the LMF requests UE1 and UE2 to perform ranging over PC5 or establishes two absolute positioning sessions with each UE to obtain absolute positions based on the decision from operation 550.

Based upon operation 520, the AMF may return the cell IDs of where the UEs are camping. The LMF, based upon its implementation, can determine if SL ranging can be possible or not (e.g., if UEs are camping in same cell or neighbor cells or different cells). In some examples, the LMF may skip operation 560 if client request for granular/fine range estimation and the UEs are in different (e.g., far apart) cells. In this example, the LMF may return an indication of a failure, that the QoS cannot be met as ranging using SL, or simply return an absolute position of the two UEs or the distance between two UEs based upon the absolute position. If an absolute position is used to calculate the range, then at least AoA or other similar methods must be applied to calculate direction location information.

At operation 570, the LMF returns the Nlmf_Location_DetermineLocation Response towards the AMF to return the ranging result between UE1 and UE2.

At operation 580, the AMF forwards the ranging result between UE1 and UE2 to the requesting entity.

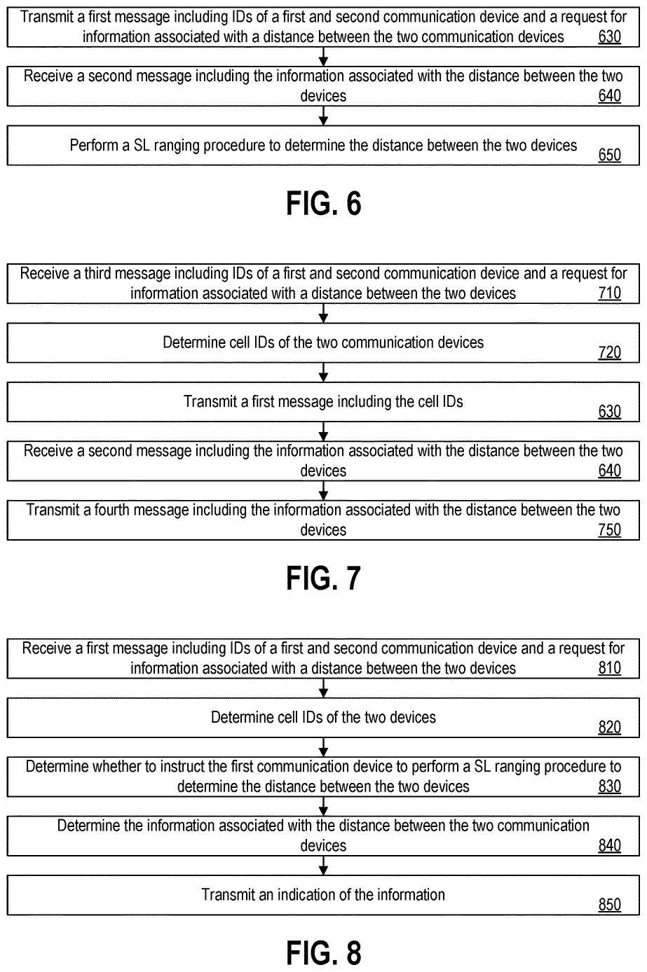

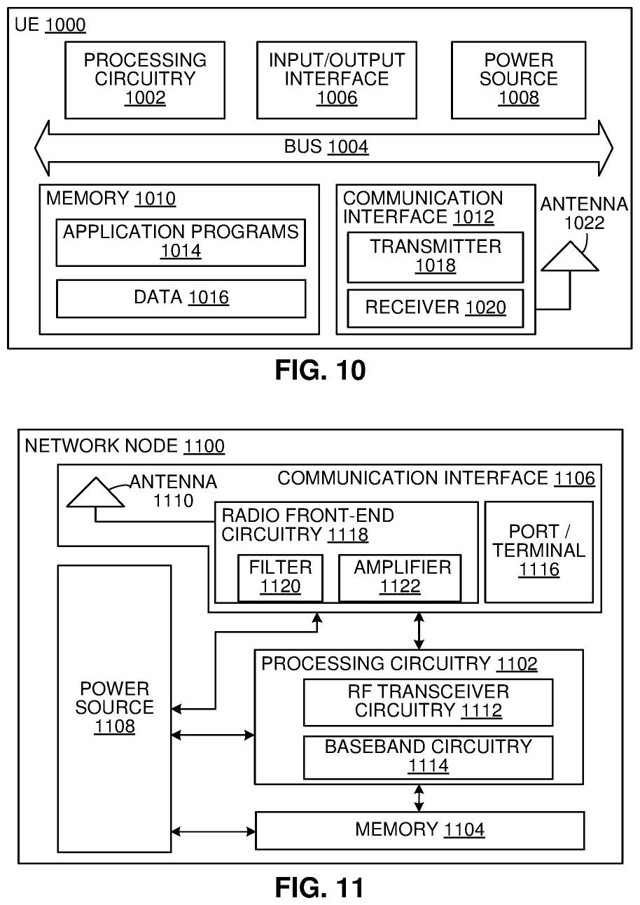

Operations of the communication device 1000 (implemented using the structure of FIG. 10) will now be discussed with reference to the flow chart of FIG. 6 according to some embodiments of inventive concepts. For example, modules may be stored in memory 1010 of FIG. 10, and these modules may provide instructions so that when the instructions of a module are executed by respective communication device processing circuitry 1002, communication device 1000 performs respective operations of the flow chart.

FIG. 6 illustrates an example of operations performed by a client device.

At block 630, processing circuitry 1002 transmits, via communication interface 1012, a first message from a client device including IDs of UE1 and UE2 and a request for information associated with a distance between UE1 and UE2. In some examples, the first message includes a precision requirement associated with the distance.

In some embodiments, the client device is configured as UE1, an external device separate from UE1, or an AMF. Where the client device is UE1, the ID of UE1 can include a subscription permanent ID (“SUPI”) and an application layer ID. Where the client device is an external device separate from UE1, the ID of UEL can include a Uu ID.

At block 640, the client device receives a second message including the information associated with the distance between UE1 and UE2. In some embodiments, the information includes an instruction for UE1 to perform a SL ranging procedure to determine the distance between UE1 and UE2. In some examples, where the client is UE1, at block 650, UE1 performs the SL ranging procedure to determine the distance between UE1 and UE2.

In additional or alternative examples, the second message includes an indication that the precision requirement cannot be guaranteed, the distance between UE1 and UE2 exceeds a threshold distance, and/or that UE1 is unable to determine the distance between UE1 and UE2 using SL communication. In other examples, the second message comprises an indication of an absolute position of UE1, an absolute position of UE2, and/or the distance between UE1 and UE2.

Various operations from the flow chart of FIG. 6 may be optional with respect to some embodiments of communication devices and related methods.

Operations of the RAN node 1100 (implemented using the structure of FIG. 11) will now be discussed with reference to the flow charts of FIGS. 7-8 according to some embodiments of inventive concepts. For example, modules may be stored in memory 1104 of FIG. 11, and these modules may provide instructions so that when the instructions of a module are executed by respective RAN node processing circuitry 1102, RAN node 1100 performs respective operations of the flow charts.

FIG. 7 illustrates an example of operations performed by a client device, where the client device is an AMF.

At block 710, processing circuitry 1102 receives, via communication interface 1106, a third message including IDs of UE1 and UE2 and a request for information associated with a distance between UE1 and UE2.

At block 720, the AMF determines serving cell IDs of UEL and UE2.

At block 630, similar to as described above in regards to FIG. 6, the AMF transmits a first message (including the cell ID of UE1). In some examples, the first message further includes a Uu ID, the cell ID of UE2, and a request for information associated with a distance between UE1 and UE2. In additional or alternative examples, the first message includes a precision requirement associated with the distance.

block 640, similar to as described above in regards to FIG. 6, the AMF receives a second message including the information associated with the distance between UE1 and UE2. In some examples, the information comprises an instruction for UE1 to perform a SL ranging procedure to determine the distance between UE1 and UE2.

In additional o alternative examples, the second message comprises an indication that the precision requirement cannot be guaranteed, the distance between UE1 and UE2 exceeds a threshold distance, and/or that the first communication device is unable to determine the distance between UE1 and UE2 using SL communication. In other examples, the second message comprises an indication of an absolute position of UE1, an absolute position of UE2, and/or the distance between UE1 and UE2.

At block 750, the AMF transmits a fourth message including the information associated with the distance between UE1 and UE2.

FIG. 8 illustrates an example of operations performed by a network node configured to provide a location server (e.g., a LMF).

At block 810, processing circuitry 1102 of a network node receives, via communication interface 1106 a first message including IDs of UE1 and UE2 and a request for information associated with a distance between UE1 and UE2. In other examples, the first message includes a precision requirement associated with the distance.

In additional or alternative examples, where the network node receives the first message from an AMF, the message includes a serving cell ID for UE1 and UE2. In other examples, the network node receives the first message from UE1 or an external device separate from UE1, UE2, and the network node.

At block 820, where the network node is further configured to provide an AMF, the AMF determines serving cell IDs of UE1 and UE2.

At block 830, the network node determines whether to instruct UE1 to perform a SL ranging procedure to determine the distance between UE1 and UE2. In some examples, this determination is made based on the serving cell IDs of UE1 and UE2. In other examples, the determination comprises determining not to instruct UE1 to perform the SL ranging procedure because the distance between the serving cells of UE1 and UE2 exceed a threshold distance, that either UE1 or UE2 do not support SL positioning, and/or that a SUPI was obtained for UE1 and UE2, but an application layer ID was not obtained for UE2.

Based on the determination in block 830, at block 840, the network node further determines the information associated with a distance between UE1 and UE2. In some examples, the information includes an indication that the precision requirement cannot be guaranteed and/or that UE1 is unable to determine the distance between UE1 and UE2 using SL communication. In additional or alternative examples, the information includes an indication of an absolute position of UE1, an absolute position of UE2, and/or the distance between UE1 and UE2. In additional or alternative examples, the information includes an instruction for UE1 to perform the SL ranging procedure to determine the distance between UE1 and UE2.

At block 850, the network node transmits an indication of this information. In some examples, the information is transmitted to an AMF, UE1, UE2, and/or an external client.

Various operations from the flow charts of FIGS. 7-8 may be optional with respect to some embodiments of RAN nodes and related methods.

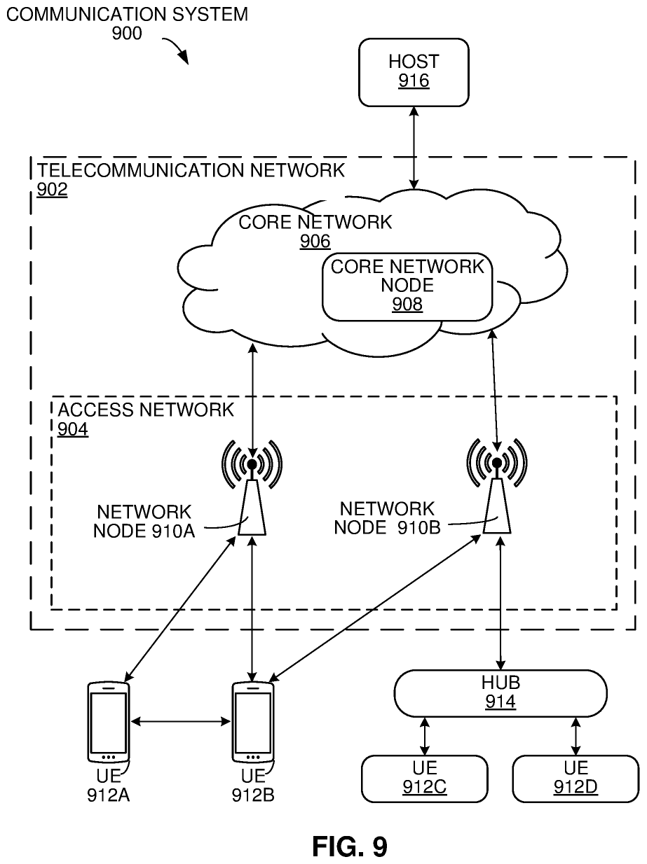

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3rd Generation Partnership Project (3GPP) access node or non-3GPP access point. Moreover, as will be appreciated by those of skill in the art, the network nodes 910 are not necessarily limited to an implementation in which a radio portion and a baseband portion are supplied and integrated by a single vendor. Thus, it will be understood that the network nodes 910 may include disaggregated implementations or portions thereof. For example, in some embodiments, the telecommunication network 902 includes one or more Open-RAN (ORAN) network nodes. An ORAN network node is a node in the telecommunication network 902 that supports an ORAN specification (e.g., a specification published by the O-RAN Alliance, or any similar organization) and may operate alone or together with other nodes to implement one or more functionalities of any node in the telecommunication network 902, including one or more network nodes 910 and/or core network nodes 908.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 910 facilitate direct or indirect connection of user equipment (UE), such as by connecting wireless devices 912a, 912b, 912c, and 912d (one or more of which may be generally referred to as UEs 912) to the core network 906 over one or more wireless connections. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

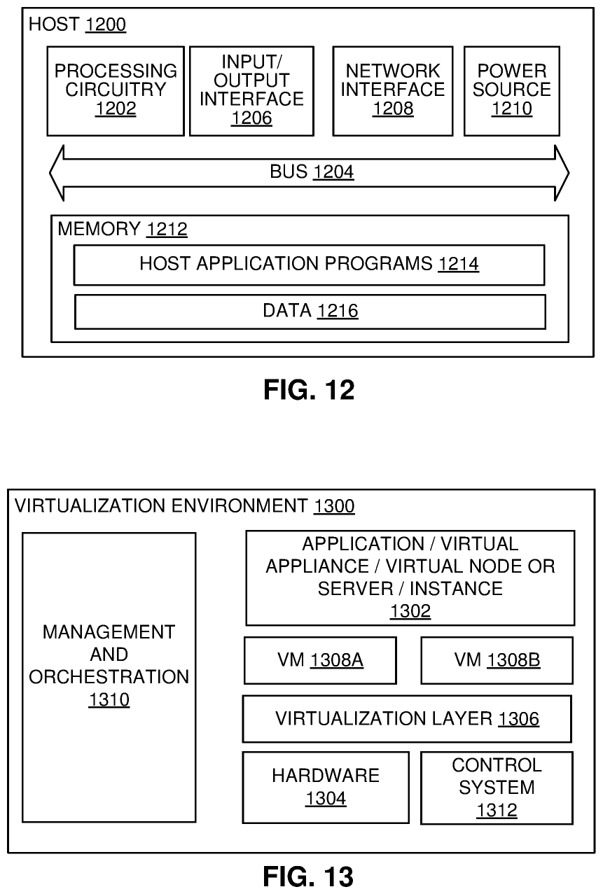

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1300 includes components defined by the O-RAN Alliance, such as an O-Cloud environment orchestrated by a Service Management and Orchestration Framework via an O-2 interface.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

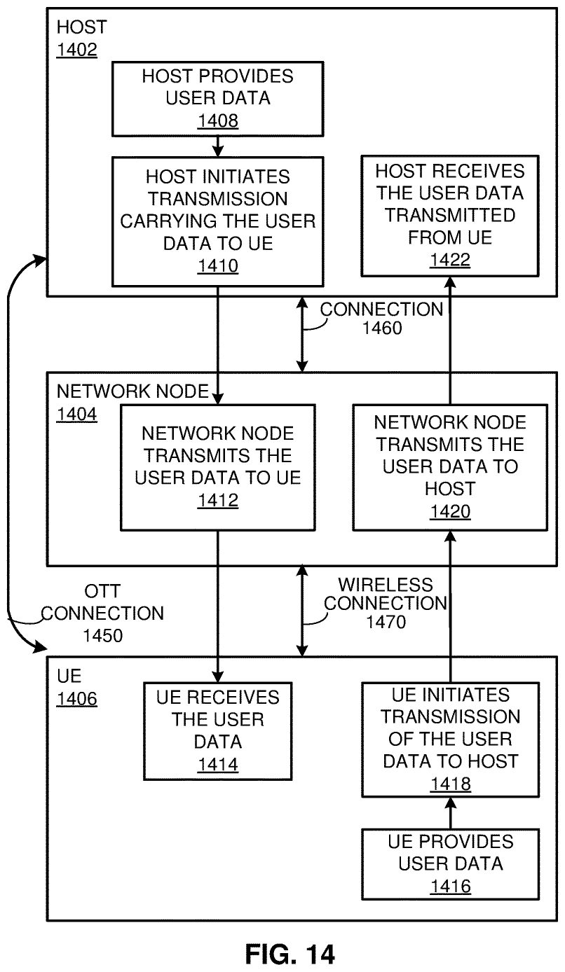

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, the teachings of these embodiments may enable a LMF to choose a suitable procedure of obtaining a ranging result, which can guarantee a QoS of the ranging.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example Embodiments are described below.

Embodiment 1. A method of operating a client device, the method comprising:
transmitting (630) a first message including a first identifier, ID, of a first communication device, a second ID of a second communication device, and a request for information associated with a distance between the first communication device and the second communication device; and
receiving (640) a second message including the information associated with the distance between the first communication device and the second communication device.

Embodiment 2. The method of Embodiment 1, wherein the client device is configured to provide a location service, LCS, client, the client device comprising at least one of:
the first communication device;
an access mobility management function, AMF; and
an external device separate from the first communication device, the second communication device, and a network node configured to provide the AMF.

Embodiment 3. The method of any of Embodiments 1-2, wherein the first message further includes a precision requirement associated with the distance.

Embodiment 4. The method of Embodiment 3, wherein the information comprises an indication that the precision requirement cannot be guaranteed.

Embodiment 5. The method of any of Embodiments 1-4, wherein the information comprises an indication that the distance between the first communication device and the second communication device is above a threshold distance.

Embodiment 6. The method of any of Embodiments 1-5, wherein the information comprises an indication that the first communication device is unable to determine the distance between the first communication device and the second communication device using sidelink, SL, communication.

Embodiment 7. The method of any of Embodiments 1-6, wherein the information comprises an indication of at least one of:
an absolute position of the first communication device;
an absolute position of the second communication device; and
the distance between the first communication device and the second communication device.

Embodiment 8. The method of any of Embodiments 1-2, wherein the information comprises instruction for the first communication device to performing a sidelink, SL, ranging procedure to determine the distance between the first communication device and the second communication device.

Embodiment 9. The method of Embodiment 8, wherein the client is the first communication device,
the method further comprising:
   performing (650) the SL ranging procedure to determine the distance between the first communication device and the second communication device.

Embodiment 10. The method of any of Embodiments 1-9, wherein the client is the first communication device, and
wherein the first ID of the first communication device comprises a subscription permanent ID, SUPI, and an application layer ID.

Embodiment 11. The method of any of Embodiments 1-8, wherein the client is separate from the first communication device, and
wherein the first ID of the first communication device comprises a Uu ID.

Embodiment 12. The method of any of Embodiments 1-8 and 11, wherein the client is the AMF,
the method further comprising:
   prior (710) to transmitting the first message, receiving a third message including the first identifier ID of the first communication device, the second ID of the second communication device, and the request for information associated with the distance between the first communication device and the second communication device; and
   determining (720) a first serving cell ID associated with the first communication device and a second serving cell ID associated with the second communication device, wherein the first message further includes the first cell ID and the second cell ID; and
   subsequent to receiving the second message, transmitting (750) a fourth message including the information associated with the distance between the first communication device and the second communication device.

Embodiment 13. A method of operating a network node configured to provide a location server, the method comprising:
receiving (810) a first message including a first identifier, ID, of a first communication device, a second ID of a second communication device, and a request for information associated with a distance between the first communication device and the second communication device; and
determining (830) whether to instruct the first communication device to perform a sidelink, SL, ranging procedure to determine the distance between the first communication device and the second communication device;
determining (840) the information associated with the distance between the first communication device and the second communication device based on determining whether to instruct the first communication device to perform the SL ranging procedure; and
transmitting (850) an indication of the information.

Embodiment 14. The method of Embodiment 13, wherein receiving the first message comprises receiving the first message from an access mobility management function, AMF, and
wherein the first message further comprises a first serving cell ID associated with the first communication device and a second serving cell ID associated with the second communication device.

Embodiment 15. The method of Embodiment 13, wherein the network node is further configured to provide an access mobility management function, AMF,
wherein receiving the first message comprises receiving the first message from the first communication device or an external device that is separate from the first communication device, the second communication device, and the network node,
the method further comprising:
   determining (820) a first serving cell ID associated with the first communication device and a second serving cell ID associated with the second communication device.

Embodiment 16. The method of any of Embodiments 14-15, wherein determining whether to instruct the first communication device to perform the SL ranging procedure to determine the distance comprises determining whether to instruct the first communication device to perform the SL ranging procedure to determine the distance based on the first serving cell ID and the second serving cell ID.

Embodiment 17. The method of any of Embodiments 13-16, wherein the first message further comprises a precision requirement associated with the distance.

Embodiment 18. The method of Embodiment 17, wherein the information includes an indication that the precision requirement cannot be guaranteed.

Embodiment 19. The method of any of Embodiments 13-18, wherein determining whether to instruct the first communication device to perform the SL ranging procedure comprises determining to not instruct the first communication device to perform the SL ranging procedure based on at least one of:
a distance between a first serving cell associated with the first communication device and a second serving cell associated with the second communication device exceeding a threshold distance;
the first communication device or the second communication device does not support SL positioning; and
obtaining a subscription permanent ID, SUPI for each of the first communication device and the second communication device and failing to obtain an application layer ID of the second communication device.

Embodiment 20. The method of Embodiment 19, wherein the information includes an indication that the first communication device is unable to determine the distance between the first communication device and the second communication device using sidelink, SL, communication.

Embodiment 21. The method of any of Embodiments 19-20, wherein determining the information comprises determining at least one of:

an absolute position of the first communication device;

an absolute position of the second communication device; and

the distance between the first communication device and the second communication device.

Embodiment 22. The method of any of Embodiments 13-17, wherein determining whether to instruct the first communication device to perform the SL ranging procedure comprises determining to instruct the first communication device to perform the SL ranging procedure based on at least one of:
the first communication device and the second communication device having a common serving cell;
the first communication device and the second communication device having neighboring serving cells;
a distance between a first serving cell associated with the first communication device and a second serving cell associated with the second communication device being below a threshold distance;
the first communication device and the second communication device supporting a common local map;
one of the first communication device and the second communication device being out of network coverage;
the first communication device and the second communication device both supporting SL positioning; and
obtaining a subscription permanent ID, SUPI, associated with the first communication device and an application layer ID associated with the second communication device.

Embodiment 23. The method of Embodiment 22, wherein the information includes an instruction for the first communication device to performing the SL ranging procedure to determine the distance between the first communication device and the second communication device.

Embodiment 24. The method of any of Embodiments 13-23, wherein the first ID of the first communication device and the second ID of the second communication device each comprise at least one of:
a subscription permanent ID, SUPI;
an application layer ID; and
a Uu ID.

Embodiment 25. A communication device (1000), the communication device comprising:
processing circuitry (1002); and
memory (1010) coupled to the processing circuitry and having instructions stored therein that are executable by the processing circuitry to cause the communication device to perform operations comprising any of the operations of Embodiments 1-10.

Embodiment 26. A computer program comprising program code to be executed by processing circuitry (1002) of a communication device (1000), whereby execution of the program code causes the communication device to perform operations comprising any operations of Embodiments 1-10.

Embodiment 27. A computer program product comprising a non-transitory storage medium (1010) including program code to be executed by processing circuitry (1002) of a communication device (1000), whereby execution of the program code causes the communication device to perform operations comprising any operations of Embodiments 1-10.

Embodiment 28. A non-transitory computer-readable medium having instructions stored therein that are executable by processing circuitry (1002) of a communication device (1000) to cause the communication device to perform operations comprising any of the operations of Embodiments 1-10.

Embodiment 29. A network node (1100), the network node comprising:
processing circuitry (1102); and
memory (1104) coupled to the processing circuitry and having instructions stored therein that are executable by the processing circuitry to cause the network node to perform operations comprising any of the operations of Embodiments 1-8 and 11-24.

Embodiment 30. A computer program comprising program code to be executed by processing circuitry (1102) of a network node (1100), whereby execution of the program code causes the network node to perform operations comprising any operations of Embodiments 1-8 and 11-24.

Embodiment 31. A computer program product comprising a non-transitory storage medium (1104) including program code to be executed by processing circuitry (1102) of a network node (1100), whereby execution of the program code causes the network node to perform operations comprising any operations of Embodiments 1-8 and 11-24.

Embodiment 32. A non-transitory computer-readable medium having instructions stored therein that are executable by processing circuitry (1102) of a network node (1100) to cause the network node to perform operations comprising any of the operations of Embodiments 1-8 and 11-24.

Embodiment 33. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the operations of Embodiments 1-10 to receive the user data from the host.

Embodiment 34. The host of the previous embodiment, wherein the cellular network further includes a network node configured to communicate with the UE to transmit the user data to the UE from the host.

Embodiment 35. The host of the previous 2 embodiments, wherein:
the processing circuitry of the host is configured to execute a host application, thereby providing the user data; and
the host application is configured to interact with a client application executing on the UE, the client application being associated with the host application.

Embodiment 36. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of Embodiments 1-10 to receive the user data from the host.

Embodiment 37. The method of the previous embodiment, further comprising:
at the host, executing a host application associated with a client application executing on the UE to receive the user data from the UE.

Embodiment 38. The method of the previous embodiment, further comprising:
at the host, transmitting input data to the client application executing on the UE, the input data being provided by executing the host application,
wherein the user data is provided by the client application in response to the input data from the host application.

Embodiment 39. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the operations of Embodiments 1-10 to transmit the user data to the host.

Embodiment 40. The host of the previous embodiment, wherein the cellular network further includes a network node configured to communicate with the UE to transmit the user data from the UE to the host.

Embodiment 41. The host of the previous 2 embodiments, wherein:
the processing circuitry of the host is configured to execute a host application, thereby providing the user data; and
the host application is configured to interact with a client application executing on the UE, the client application being associated with the host application.

Embodiment 42. A method implemented by a host configured to operate in a communication system that further includes a network node and a user equipment (UE), the method comprising:
at the host, receiving user data transmitted to the host via the network node by the UE, wherein the UE performs any of the operations of Embodiments 1-10 to transmit the user data to the host.

Embodiment 43. The method of the previous embodiment, further comprising:
at the host, executing a host application associated with a client application executing on the UE to receive the user data from the UE.

Embodiment 44. The method of the previous embodiment, further comprising:
at the host, transmitting input data to the client application executing on the UE, the input data being provided by executing the host application,
wherein the user data is provided by the client application in response to the input data from the host application.

Embodiment 45. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of Embodiments 1-8 and 11-24 to transmit the user data from the host to the UE.

Embodiment 46. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 47. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of Embodiments 1-8 and 11-24 to transmit the user data from the host to the UE.

Embodiment 48. The method of the previous embodiment, further comprising, at the network node, transmitting the user data provided by the host for the UE.

Embodiment 49. The method of any of the previous 2 embodiments, wherein the user data is provided at the host by executing a host application that interacts with a client application executing on the UE, the client application being associated with the host application.

Embodiment 50. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of Embodiments 1-8 and 11-24 to transmit the user data from the host to the UE.

Embodiment 51. The communication system of the previous embodiment, further comprising:
the network node; and/or
the user equipment.

Embodiment 52. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of Embodiments 1-8 and 11-24 to receive the user data from a user equipment (UE) for the host.

Embodiment 53. The host of the previous 2 embodiments, wherein:
the processing circuitry of the host is configured to execute a host application, thereby providing the user data; and
the host application is configured to interact with a client application executing on the UE, the client application being associated with the host application.

Embodiment 54. The host of the any of the previous 2 embodiments, wherein the initiating receipt of the user data comprises requesting the user data.

Embodiment 55. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the operations of Embodiments 1-8 and 11-24 to receive the user data from the UE for the host.

Embodiment 56. The method of the previous embodiment, further comprising at the network node, transmitting the received user data to the host.

1. A method of operating a network node configured to provide a location server, the method comprising:
receiving a first message including a request for information associated with a distance between a first communication device and a second communication device;
determining whether to instruct the first communication device to perform a sidelink, SL, ranging procedure to determine the distance between the first communication device and the second communication device;
determining the information associated with the distance between the first communication device and the second communication device based on an absolute position of the first communication device and an absolute position of a second communication device; and
transmitting an indication of the information.

2. The method of claim 1, wherein receiving the first message further includes:
a first identifier, ID, of the first communication device; and
a second ID of the second communication device,
wherein the first ID of the first communication device and the second ID of the second communication device each comprise at least one of:
a subscription permanent ID, SUPI;
an application layer ID; and
a Uu ID.

3. The method of claim 1, wherein receiving the first message comprises receiving the first message from an access mobility management function, AMF, and
wherein the first message further comprises a first serving cell ID associated with the first communication device and a second serving cell ID associated with the second communication device.

4. The method of claim 1, wherein the network node is further configured to provide an access mobility management function, AMF,
wherein receiving the first message comprises receiving the first message from the first communication device or an external device that is separate from the first communication device, the second communication device, and the network node,
the method further comprising:
determining a first serving cell ID associated with the first communication device and a second serving cell ID associated with the second communication device.

5. The method of claim 1, wherein determining whether to instruct the first communication device to perform the SL ranging procedure to determine the distance comprises determining whether to instruct the first communication device to perform the SL ranging procedure to determine the distance based on the first serving cell ID and the second serving cell ID.

6. The method of claim 1, wherein the first message further comprises a precision requirement associated with a measurement of the distance.

7. (canceled)

8. The method of claim 1, wherein determining whether to instruct the first communication device to perform the SL ranging procedure comprises determining to not instruct the first communication device to perform the SL ranging procedure based on at least one of:
a distance between a first serving cell associated with the first communication device and a second serving cell associated with the second communication device exceeding a threshold distance;
the first communication device or the second communication device does not support SL positioning; and
obtaining a subscription permanent identifier, SUPI for each of the first communication device and the second communication device and failing to obtain an application layer identifier, ID, of the second communication device.

9. (canceled)

10. The method of claim 1, wherein determining whether to instruct the first communication device to perform the SL ranging procedure comprises determining to instruct the first communication device to perform the SL ranging procedure based on at least one of:
the first communication device and the second communication device having a common serving cell;
the first communication device and the second communication device having neighboring serving cells;
a distance between a first serving cell associated with the first communication device and a second serving cell associated with the second communication device being below a threshold distance;
the first communication device and the second communication device supporting a common local map;
one of the first communication device and the second communication device being out of network coverage;
the first communication device and the second communication device both supporting SL positioning; and
obtaining a subscription permanent ID, SUPI, associated with the first communication device and an application layer ID associated with the second communication device.

11. (canceled)

12. The method of claim 1, wherein determining the information associated with the distance between the first communication device and the second communication device comprises:
receiving an indication of the distance between the first communication device and the second communication device determined via the SL ranging procedure; and
determining the distance between the first communication device and the second communication device based on the indication of the distance, the absolute position of the first communication device, and the absolute position of the second communication device.

13. (canceled)

14. The method of claim 1, wherein the location server comprises a location management function, LMF.

15. A method of operating a client device, the method comprising:
transmitting a first message including a request for information associated with a distance between a first communication device and a second communication device; and
receiving a second message including the information associated with the distance between the first communication device and the second communication device, the information associated with the distance between the first communication device and the second communication device including an indication that the distance between the first communication device and the second communication device was determined based on an absolute position of the first communication device and an absolute position of the second communication device.

16. The method of claim 15, wherein the client device is configured to provide a location service, LCS, client, the client device comprising at least one of:
the first communication device;
an access mobility management function, AMF; and
an external device separate from the first communication device, the second communication device, and a network node configured to provide the AMF.

17. The method of claim 16, wherein the client device is the first communication device,
the method further comprising:
receiving a request that the first communication device provide sidelink, SL, positioning measurements or Uu positioning measurements; and
transmitting an indication of the SL positioning measurements or the Uu positioning measurements.

18. The method of claim 15, wherein the first message further includes:
a first identifier, ID, of the first communication device; and
a second ID of the second communication device, and

19. The method of claim 18, wherein the client is the first communication device, and
wherein the first ID of the first communication device comprises a subscription permanent ID, SUPI, and an application layer ID.

20. The method of claim 18, wherein the client is separate from the first communication device, and
wherein the first ID of the first communication device comprises a Uu ID.

21. The method of claim 15, wherein the first message further includes a precision requirement associated with the distance.

22. (canceled)

23. The method of claim 15, wherein receiving the information comprises receiving an indication of at least one of:
the absolute position of the first communication device;
the absolute position of the second communication device; and
the distance between the first communication device and the second communication device.

24-30. (canceled)

31. A communication device comprising:
processing circuitry; and
memory coupled to the processing circuitry and having instructions stored therein that are executable by the processing circuitry to cause the communication device to perform operations comprising:
transmitting a first message including a request for information associated with a distance between a first communication device and a second communication device; and
receiving a second message including the information associated with the distance between the first communication device and the second communication device, the information associated with the distance between the first communication device and the second communication device including an indication that the distance between the first communication device and the second communication device was determined based on an absolute position of the first communication device and an absolute position of the second communication device.

32.-38. (canceled)

39. A network node comprising:
processing circuitry; and
memory coupled to the processing circuitry and having instructions stored therein that are executable by the processing circuitry to cause the network node to perform operations comprising:
receiving a first message including a request for information associated with a distance between a first communication device and a second communication device;
determining whether to instruct the first communication device to perform a sidelink, SL, ranging procedure to determine the distance between the first communication device and the second communication device;
determining the information associated with the distance between the first communication device and the second communication device based on an absolute position of the first communication device and an absolute position of a second communication device; and
transmitting an indication of the information.

40. (canceled)
